(19) United States
(12) Patent Application Publication
(10) Pub. No.: US 2026/0211430 A1
(43) Pub. Date: Jul. 23, 2026

(54) CONTROL SYSTEM FOR A CONFIGURABLE UNMANNED AERIAL VEHICLE SYSTEM

(71) Applicant: Arizona Board of Regents on Behalf of the University of Arizona, Tucson, AZ (US)

(72) Inventor: Hossein Rastgoftar, Tucson, AZ (US)

(21) Appl. No.: 19/157,853

(22) PCT Filed: Feb. 21, 2024
(86) PCT No.: PCT/US2024/016689

§ 371 Date: Aug. 19, 2025

Related U.S. Application Data
(60) Provisional application No. 63/447,328, filed on Feb. 21, 2023.

(51) Int. Cl. G05D 1/695; G05D 1/248; G05D 1/633; G05D 1/693; G05D 109/25; G05D 111/50

(52) U.S. Cl. CPC G05D 1/696; G05D 1/248; G05D 1/633; G05D 1/693; G05D 2109/254; G05D 2111/52

(57) ABSTRACT

An unmanned vehicle system includes a first non-terminal cell enclosing a plurality of terminal cells, a second non-terminal cell enclosing a second plurality of terminal cells, each terminal cell enclosing a respective UAV; a first linkage member fixedly coupled to the first non-terminal cell; a second linkage member movably coupled to the second non-terminal cell; a pivot joint to pivotally couple the first and second linkage members; the first and second non-terminal cells are arranged in a single plane, and first and second linkage members and the pivot joint provide controllable movement of the first and second non-terminal cells with respect to one another and within the single plane; and controller circuitry to control each respective UAV to generate a target upward force, a target roll, and a target pitch, and a target position of the first non-terminal cell with respect to the second non-terminal cell within the single plane.

### CROSS-REFERENCE TO RELATED APPLICATIONS

This application is National Phase application filed under 35 USC § 371 of PCT Application No. ______ with an international filing date of ______, which claims the benefit of U.S. Provisional Application Ser. No. 63/447,328, filed Feb. 21, 2023. Each of these applications is herein incorporated by reference in its entirety for all purposes.

### STATEMENT REGARDING FEDERALLY SPONSORED RESEARCH OR DEVELOPMENT

This invention was made with government support under Grant No. 2133690 awarded by the National Science Foundation. The government has certain rights in the invention.

### TECHNICAL FIELD

The present disclosure relates to control systems for a configurable unmanned aerial vehicle system.

### BACKGROUND

Multi-copter unmanned aerial vehicles (UAVs) have previously found numerous applications ranging from disaster relief and payload transport to military and scientific missions. Comparing with fixed-wing UAVs, multi-copter UAVs, equipped with high resolution sensors, are enabled to collect more accurate information and data in an aerial surveillance. However, available copter-based UAVs can fly for about 15 to 30 minutes which limits their applicability for long-duration missions. Additionally, a single drone operation is not robust to actuation (or sensor) failure with limited to no capability of recovering safety under anomalous situations.

### BRIEF DESCRIPTION OF THE DRAWINGS

Reference should be made to the following detailed description which should be read in conjunction with the following figures, wherein like numerals represent like parts.

FIG. 1 is a functional block diagram of one example configuration of a Deformable Copter-powered UAV (DCU), consistent with the present disclosure.

FIG. 2A is a reference configuration of one possible example configuration of a DCU, consistent with the present disclosure.

FIG. 2B is the deformed configuration of the DCU of FIG. 2A.

FIG. 3 is a schematic diagram of two connecting circular guides, consistent with the present disclosure.

FIG. 4A illustrates the rotation of the DCU with respect to the inertial coordinate system, consistent with the present disclosure.

FIG. 4B illustrates the rotation of the UAV with respect to the DCU body coordinate system, consistent with the present disclosure.

FIG. 5 is an example block-diagram of DCU motion control, consistent with the present disclosure.

FIG. 6 is a flow chart diagram depicting operations for an illustrative example embodiment of a method for control of a configurable unmanned aerial vehicle system on the system 100 of FIG. 1, consistent with the present disclosure.

FIG. 7 is TABLE I, which contains characteristic indices, consistent with the present disclosure.

FIG. 8 is TABLE II, showing Non-zero Generalized Angular Velocity Vectors, consistent with the present disclosure.

FIG. 9 is TABLE III, showing generalized velocity vectors of leader and follower bars, consistent with the present disclosure.

FIG. 10 is TABLE IV, showing non-zero generalized velocity vectors of guides and UAVs, consistent with the present disclosure.

FIGS. 11A-D are examples of position components of one example UAV versus time, consistent with the present disclosure.

FIGS. 12A-B are examples of row and yaw angles versus time of one example of a group of UAVs, consistent with the present disclosure.

FIG. 12C is an example of thrust force magnitudes of the example group of UAVs from FIGS. 13A-B, consistent with the present disclosure.

FIG. 13 is an example plot of desired position components of the DCU versus time for a failure-resilient operation scenario, consistent with the present disclosure.

FIG. 14A is an example of thrust force magnitudes of two UAVs, consistent with the present disclosure.

FIG. 14B is an example of thrust force magnitudes of the four remaining UAVs, consistent with the present disclosure.

FIGS. 15-53 contain equations 1a-39c.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

Multi-copter UAVs have previously found numerous applications ranging from disaster relief and payload transport to military and scientific missions. Comparing with fixed-wing UAVs, multi-copter UAVs, equipped with high resolution sensors, are enabled to collect and more accurate information of data in an aerial surveillance. However, a single-drone operation is not robust to actuation or sensor failure with limited to no capability of recovering safety under anomalous situations.

The present disclosure presents dynamics and control models for a Deformable Copter-powered UAV (DCU) with the capability of safe aggressive deformation in a constrained environment. The DCU is a multi-body system with 27 degrees of freedom and a plurality of rigid bodies, including UAVs, circular guides with inner and outer rails, and bars, and joints. The disclosed system applies the Kane's method to obtain the dynamics of the DCU deformation in a three-dimensional (3D) motion space. The paper also discloses a DCU trajectory tracking control which is decomposed into force and attitude controls and presented as quadratic programming problems.

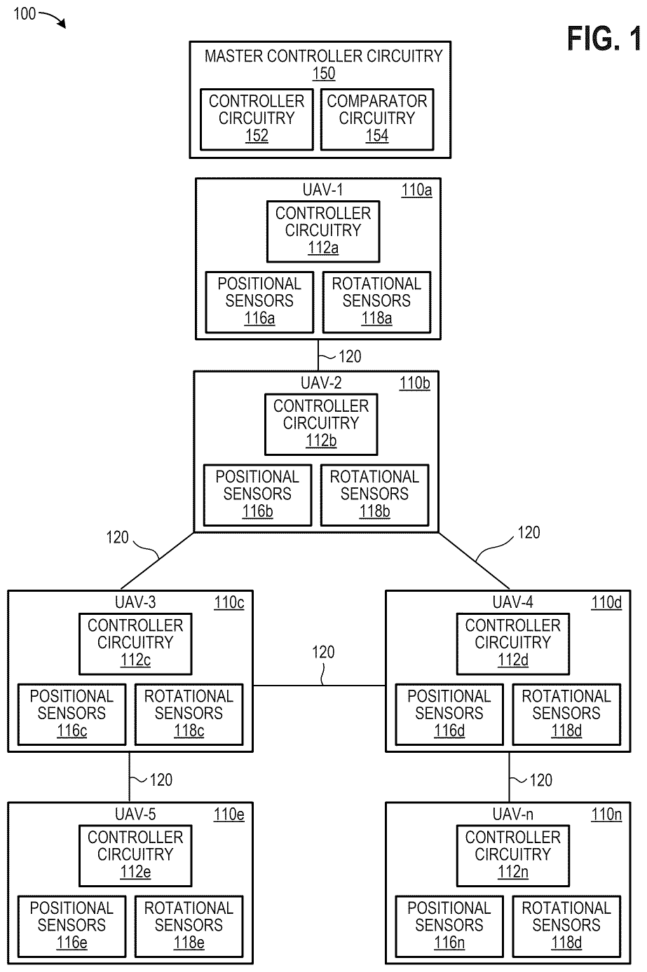

FIG. 1 is a functional block diagram of system 100 illustrating one example configuration of a DCU, consistent with the present disclosure. System 100 includes a plurality of UAVs, including UAV-1 110a, UAV-2 110b, UAV-3 110c, UAV-4 110d, UAV-5 110e, and UAV-n 110n, all communicatively coupled by links 120. In an embodiment, links 120 may be any medium for communicatively coupling UAV-1 110a through UAV-n 110n, which may include, but is not limited to, wired, wireless, or optical communication links. As shown in FIG. 1, each UAV may have one or more links 120 to communicatively couple with one or more other UAVs.

In the illustrated example of system 100, each UAV includes controller circuitry, i.e., controller circuitry 110a for UAV-1 110a, controller circuitry 112b for UAV-2 110b, controller circuitry 112c for UAV-3 110c, controller circuitry 112d for UAV-4 110d, controller circuitry 112e for UAV-5 110e, and controller circuitry 112n for UAV-n 110n. Each UAV also includes sensors, including positional sensors and rotational sensors, i.e., positional sensors 116a and rotational sensors 118a for UAV-1 110a, positional sensors 116b and rotational sensors 118b for UAV-2 110b, positional sensors 116c and rotational sensors 118c for UAV-3 110c, positional sensors 116d and rotational sensors 118d for UAV-4 110d, positional sensors 116e and rotational sensors 118e for UAV-5 110e, and positional sensors 116 n and rotational sensors 118 n for UAV-n 110n. In an embodiment, the position sensors may include, but are not limited to, Global Positioning System (GPS) sensors, or cooperative localizations. In an embodiment, the sensors on any UAV may include Inertial Measurement Unit (IMU) sensors, for example, for sensing orientation of the UAV.

System 100 also includes master controller circuitry 150. The master controller circuitry 150 performs overall control functions for the DCU as described below. The master control circuitry 150 includes controller circuitry 152. In an embodiment, the master control circuitry 150 may be incorporated into any of UAV-1 110a through UAV-n 110n. For example, the functions of the master controller circuitry 150 may be performed by the controller circuitry of UAV-1 110a. In another embodiment, the master control circuitry 150 may be distributed among any combination of UAV-1 110a through UAV-n 110n, including any single UAV, any combination of UAVs, or all the UAVs in the DCU.

In an embodiment, the master controller circuitry 150 may be configured to control each respective UAV to generate a target upward force generated by each respective UAV, a target roll of each respective UAV, a target pitch of each respective UAV and a target position of the first non-terminal cell with respect to the second non-terminal cell within the single plane. In an embodiment, the master controller circuitry 150 may be configured to generate second time derivative data based on the error data.

In an embodiment, the master controller circuitry 150 may include comparator circuitry 154 to compare the target upward force generated by each respective UAV, the target roll of each respective UAV, the target pitch of each respective UAV, and the target position of each respective UAV to an actual force generated by each respective UAV, an actual roll of each respective UAV, an actual pitch of each respective UAV and an actual position of each respective UAV to generate error data.

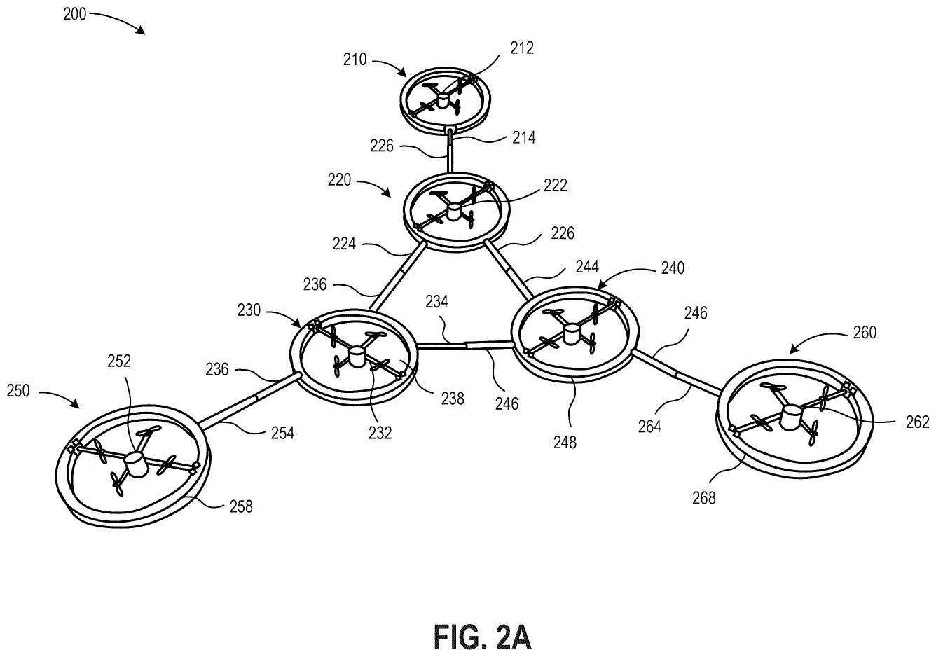

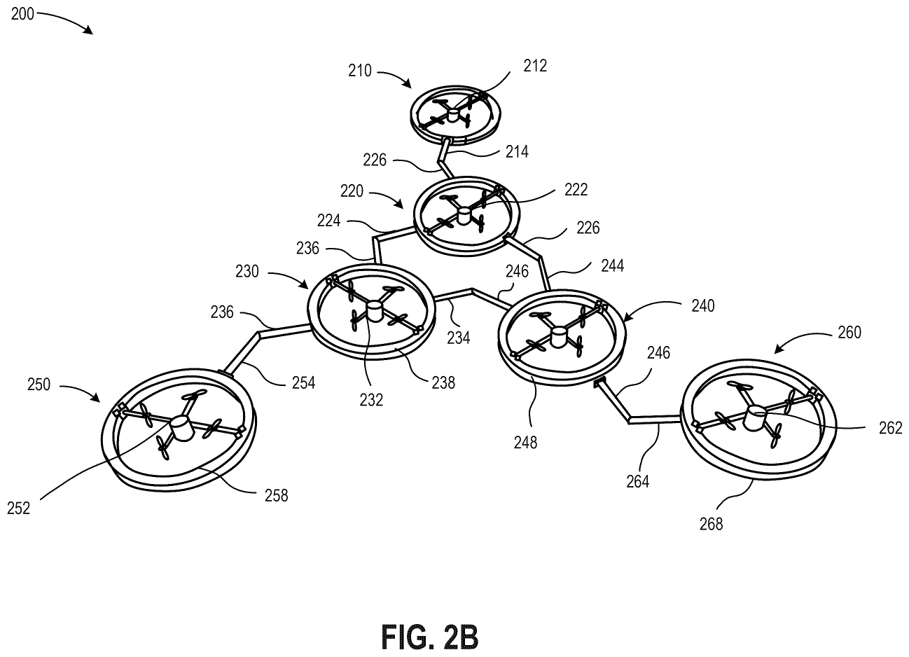

An example DCU for aerial surveillance is shown in FIGS. 2A and 2B. The example configuration of the DCU in FIGS. 2A and 2B contains 24 rigid bodies and six UAVs, where bars are indexed by 1 through 12; guides are identified by 13 through 18; and UAVs are indexed by UAV 19 through UAV 24. This configuration of a DCU with six UAVs will be used for the discussion below. It should be noted that the DCU may have any number of UAVs, as would be known to one skilled in the art. FIG. 2B is the deformed configuration of the DCU. As shown the leader bars are all fixed on the connected guides while follower bars roll on the outer rails of the connected guides.

The DCU can be equipped with a large number of on-board batteries that can be used to power its mission in a long-duration surveillance mission. While the DCU can have an aggressive planar deformation, it offers structural rigidity in every plane normal to the deformation plane of the UAV. As a result, the disclosed DCU may enhance the robustness of operations for existing copter-based UAVs against disturbance forces during inclement weather conditions. Furthermore, the DCU may benefit from redundant power due to multiple integrated UAVs, to advance the resilience of the DCU operation against failure and improve the safety recovery capabilities of UAVs.

Similar to the existing Vertical Takeoff and Landing (VTOL) UAVs, the DCU of the present disclosure can take off and land without the need for a runway. As a result, the copter-powered UAVs are highly maneuverable, and they offer the capability of flying in constrained and obstacle-laden environments at low altitude airspace.

The DCU is a multi-body system consisting of a large number of rigid bodies with many degrees of freedom. Therefore, it offers the capability of safe aggressive deformation and reconfiguration in constrained motion spaces. More specifically, multiple drones can move collectively and pass through narrow passages while inter-agent collision avoidance and safety are assured by enclosing every UAV by a circular guard and planning the desired deformation by a nonsingular trans-formation. By considering UAVs as sources producing active thrust forces and torques, this disclosure offers the following contributions, building a high-fidelity dynamics model of the DCU's motion by using the Kane's method, designing a nonlinear control for UAVs to track desired trajectories determined by an aggressive deformation of the DCU, and constructing a fault-tolerant trajectory tracking control using the power generation's redundancy.

This disclosure will explain the DCU kinematic and dynamics model, followed by the DCU trajectory tracking defined as force and attitude control problems, and give simulation results.

It should be noted that in the discussion that follows, for any character “x”, the symbol \dot{ }x is equivalent to the character “x” with a single dot over it, the symbol \ddot{ }x is equivalent to the character “x” with two dots over it, the symbol \hat{ }x is equivalent to the character “x” with a caret (or hat) over it, and the symbol \ddot{ }\hat{ }x is equivalent to the character “x” with two dots and a caret (or hat) over it.

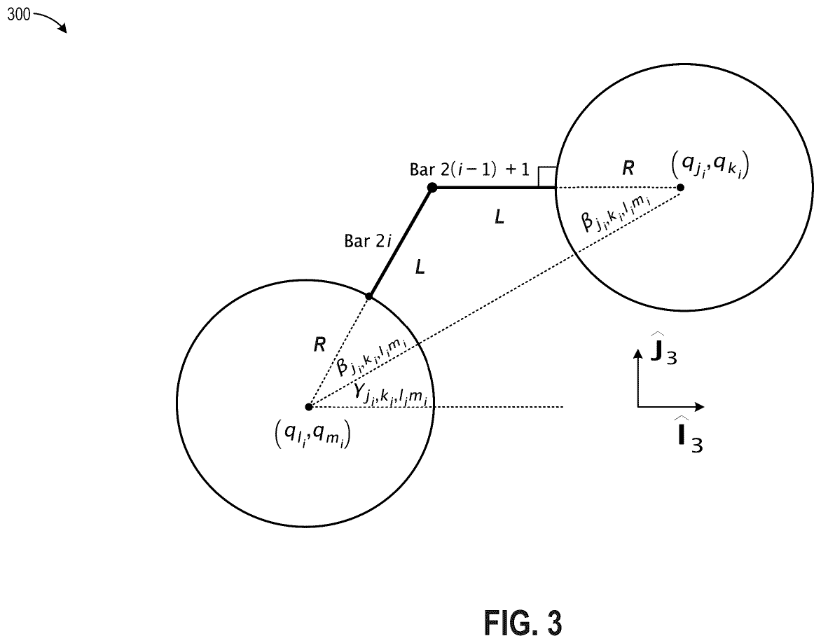

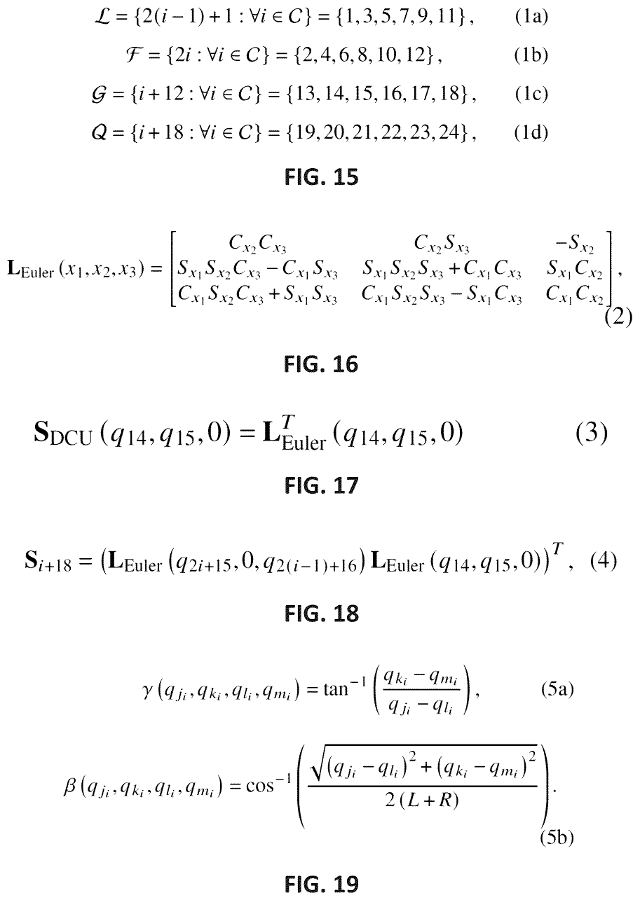

The DCU can be decomposed into six connection mechanisms which are identified by set C={1, . . . , 6} and shown by an example schematic in FIG. 3. The example schematic of FIG. 3 shows two connecting circular guides i and j by leader bar i and follower bar j. The discussion that follows is based on the example configuration shown in FIGS. 2A-2B. B can be expressed as B=L∪F∪G∪Q, where Equations 1a-1d which are shown in FIG. 15, are disjoint subsets of B defining the leader bars, follower bars, guides, and UAVs, respectively. In this paper, Mᵢ and Jᵢ denote the mass and mass moment of inertial of part i∈B, where every bar i∈L∪F has the same mass Mᵢ=M_{b} and mass moment of inertial matrix Jᵢ=J_{b}. Also, every circular guide i∈G has the same mass Mᵢ=M_{d} and the mass moment of inertia matrix Jᵢ=J_{d}; and each UAV i∈Q has the same mass Mᵢ=M_{q} and the mass moment of inertia matrix Jᵢ=J_{q}.

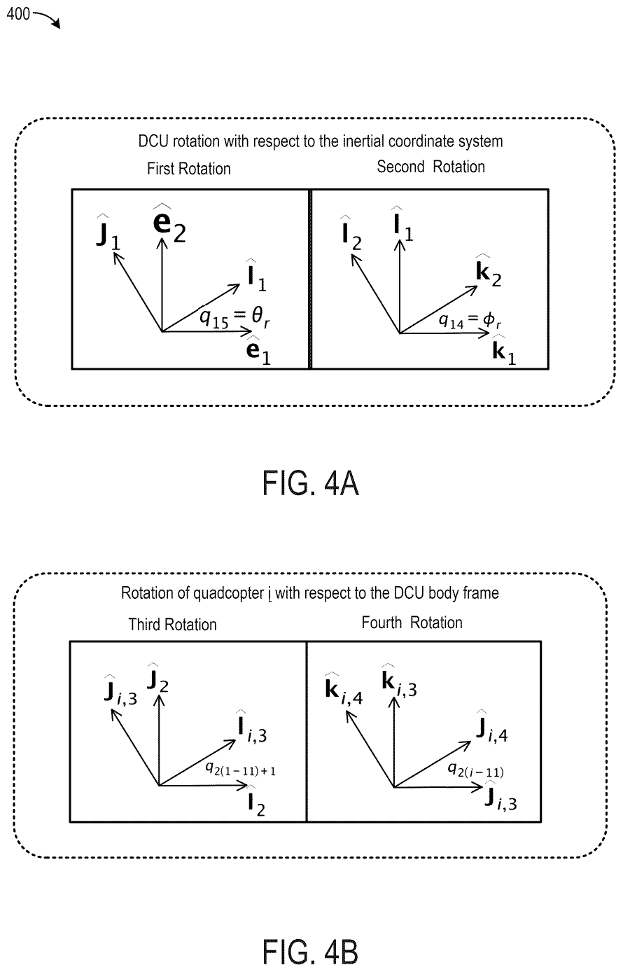

A global (an inertial) coordinate system is defined, with base vectors ê₁=[1 0 0]^{T}, ê₂=[0 1 0]^{T}, and ê₃=[0 0 1]^{T}, and the DCU local coordinate system (body frame) with base vectors \hat{ }i₂, \hat{ }j₂, and \hat{ }k₂ that can rotate with respect to the inertial coordinate system. Note that the global positions of the DCU bodies are measured with respect to the inertial coordinate system but expressed with respect to the DCU coordinate system. In particular, the component global position of UAV i+18 and circular guide i+12 are denoted by uᵢ₊₁₂, vᵢ₊₁₂, and w for every i∈C. Because the DCU is distributed in the \hat{ }i₂−\hat{ }j₂ plane, the w component of positions of all the bodies are the same. FIG. 4A illustrates the rotation of the DCU with respect to the inertial coordinate system, with base vectors e\hat{ }1, e\hat{ }2, and e\hat{ }3, characterized by roll angle q14=φr and q15=θr. FIG. 4B illustrates the rotation of the UAV i∈Q with respect to the DCU body coordinate system, with base vectors \hat{ }i3, \hat{ }j3, and k\hat{ }3, characterized by roll angle q2(i−11)+1=φ2(i−11)+1 and q2(i−10)=θ2(i−10) for every UAV i∈Q.

To model motion of the DCU in a 3D space, 27 generalized coordinates are defined denoted by q1 through q27, where (q1, q2)=(u13, v13), (q3, q4)=(u14, v14), (q5, q6)=(u15, v15), (q7, q8)=(u16, v16), (q9, q10)=(u17, v17), and (q11, q12)=(u18, v18) are global position components of the center of masses of the guides 13 through 18 in the DCU plane, made by base vector \hat{ }i2 and \hat{ }k2, q13=w is the position component of the DCU along the \hat{ }k2 axis, q14=φr and q15=θr are used to specify orientation of the DCU body coordinate system with respect to the global coordinate system, and (q16, q17)=(φ19,ψ19), (q18, q19)=(φ20,ψ20), (q20, q21)=(φ21,ψ21), (q22, q23)=(φ22,ψ22), (q24, q25)=(φ23,ψ23), and (q26, q27)=(φ24,ψ24) define the roll and yaw angles of UAV 19 through 24.

To characterize the rotation and translation of the DCU parts, with respect to the global coordinate system, the 3-2-1 Euler angles standard are used to characterize a rigid body rotation by Equation 2, which is shown in FIG. 16, where x1, x2, and x3 are the first, second, and third Euler angles, respectively.

A rotation matrix is defined in Equation 3, which is shown in FIG. 17, where i3=SDCU\hat{ }e1, j3=SDCU\hat{ }e2, and k3=SDCU\hat{ }e3 are the base vectors of the DCU body frame. For every UAV i+18∈Q (i∈C), one of the arms of UAV i+18∈Q is restricted to remain in the plane of the enclosing circular guide i+12∈G, for every i∈C. This constraint is satisfied, if the end points of the restricted arm of UAV i+18∈Q roll along the inner rail of guide i+12∈G. Therefore, it may be assumed the pitch angle (the second Euler angle) of every UAV i+18∈Q is zero at any time t. As a result, the base vectors of body frame of UAV i+18∈Q are denoted by \hat{ }I_{i+18,4}, \hat{ }j_{i+18,4}, \hat{ }k_{i+18,4} and obtain as follows i_{i+18,4}=S_{i+18 \hat{ }e1}, j_{i+18,4}=S_{i+18 \hat{ }e2}, k_{i+18,4}=Sᵢ₊₁₈ \hat{ }e3, for every ∀i∈C where Sᵢ₊₁₈=Sᵢ₊₁₈(q₂ᵢ₊₁₅, q₂₍ᵢ₋₁₎₊₁₆,q₁₄,q₁₅) using Equation 4, which is shown in FIG. 18.

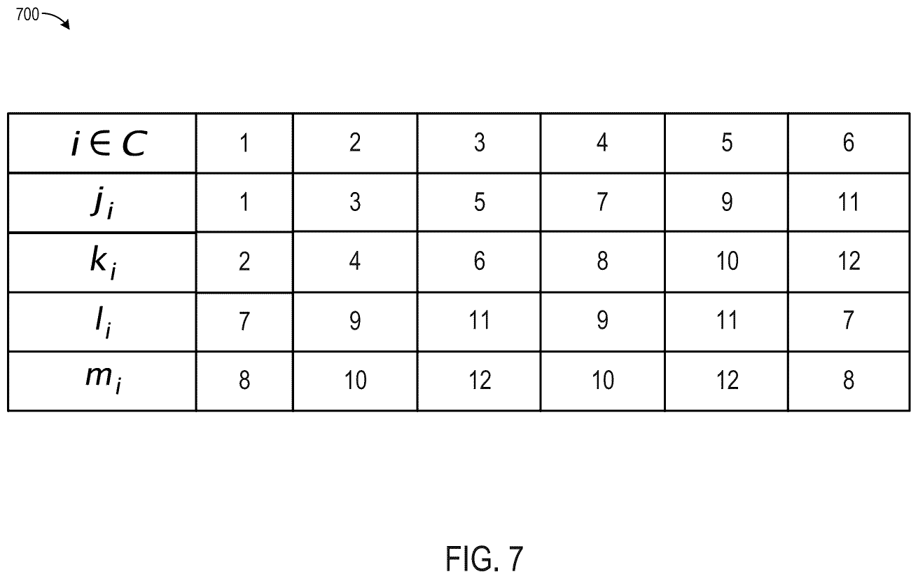

Connection of two circular guides is made by leader and follower bars as shown in FIG. 3. Every leader bar is fixed on one circular guide but the follower bar rolls on the outer rail of the other circular guide. The configuration of every mechanism i∈C can be determined by generalized coordinates q ji, qki, qli, and qmi, where the characteristic indices ji, ki, li, and mi are given in Table I 700 of FIG. 7. More specifically, (q ji, qki) and (qli, qmi) denote positions of the center of the guides connected to leader 2(i−1)+1∈L and follower 2i∈F (i∈C), respectively, in the DCU deformation plane. For every mechanism i∈C, we define γji,ki,li,mi=γ(q ji, qki, qli, qmi) and βji,ki,li,mi=β (q ji, qki, qli, qmi) as shown in Equation 5a and Equation 5b (FIG. 19).

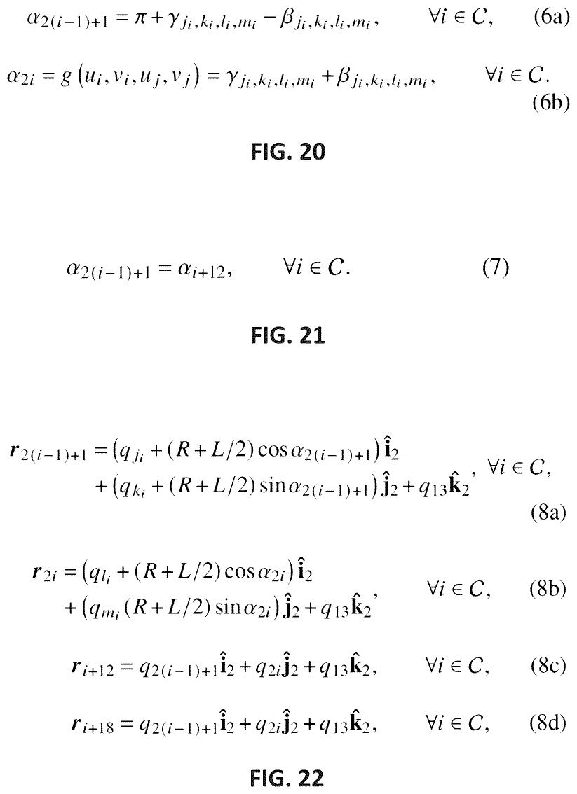

Note that leader bar 2 (i−1)+1 and follower bar 2i make angles α₂₍ᵢ₋₁₎₊₁ and α₂ᵢ with unit vector \hat{ }i₃ axis of the DCU body coordinate system, where they are obtained as shown in Equation 6a and Equation 6b (FIG. 20).

For every circular guide i+12∈G, αᵢ₊₁₂ is the same as rotation angle of the connected leader bar 2i−1∈L (for every i∈C), thus Equation 7, shown in FIG. 21.

Global positions of parts 1 through 24, with respect to an inertial coordinate system, are expressed with respect to the DCU coordinate system and given by Equation 8a-8d (FIG. 22).

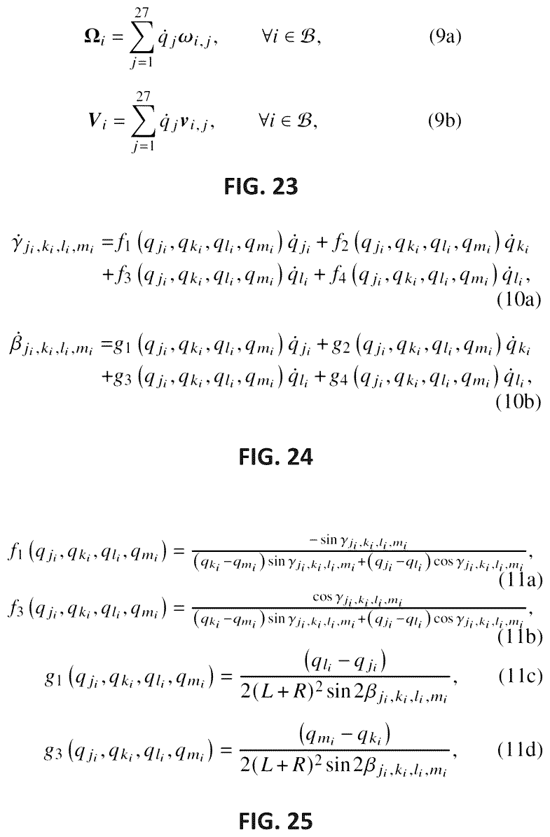

In this section, the angular velocities, and velocities of the DCU parts are obtained, and expressed as Equation 9a-9b, shown in FIG. 23, where ωi, j and vi, j are the j-th generalized angular velocity and generalized velocity, respectively, for DCU part i∈B. Note that ωi, j and vi, j are not necessarily non-zero vectors. If Ωi or Vi depends on. qⱼ, then, ω_{i, j} or v_{i, j} is a non-zero vector. Otherwise, ω_{i, j}=0 or v_{i, j}=0.

By taking time derivatives from Equations 5a and 5b, γ_{ji,ki,li,mi} and β_{ji,ki,li,mi} are obtained as shown in Equation 10a-10b (FIG. 24), where f2=−f1, f4=−f3, g2=−g1, g4=−g3, and Equations 11a-11d (FIG. 25).

It should be noted that for the rest of the disclosure, fₕ(qⱼᵢ, qₖᵢ, qₗᵢ, qₘᵢ) and gₕ(qⱼᵢ, qₖᵢ, qₗᵢ, qₘᵢ) are denoted by fh,i and gh,i, respectively, i.e., f_{h,i}=fₕ(qⱼᵢ, qₖᵢ, qₗᵢ, qₘᵢ) and g_{h,i}=gₕ(qⱼᵢ, qₖᵢ, qₗᵢ, qₘᵢ).

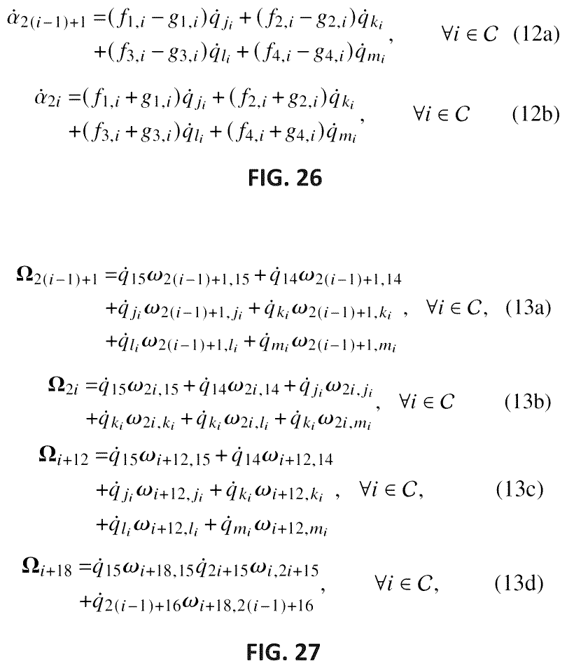

The time derivative of rotation angles of the leader and follower bars are obtained as shown in Equations 12a and 12b (FIG. 26).

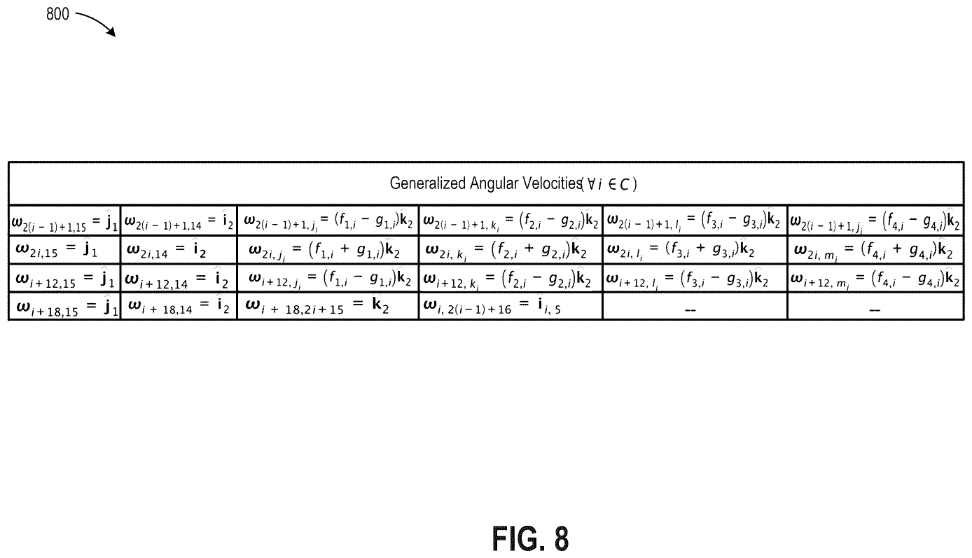

Angular velocities of the leader and follower bars, circular guides, and UAVs are obtained by Equations 13a-13d, shown in FIG. 27, where generalized angular velocities in Equations 13a-13d are given in Table II 800 of FIG. 8. Note that the angular velocities of the leader bars are the same as angular velocities of the attached guides because leader bar is fixed on circular guide at the connection point. Therefore, ω_{2(i-1)+1,15}=ω_{i+12,15}, ω_{2(i-1)+1,14}=ω_{i+12,14}, ω_{2(i-1)+1,ji}=ω_{i+12, ji}, ω_{2(i-1)+1, ki}=ω_{i+12,ki}, ω_{2(i-1)+1, li}=ω_{i+12,li}, and ω_{2(i-1)+1,mi}=ω_{i+12,mi}, for every i∈C.

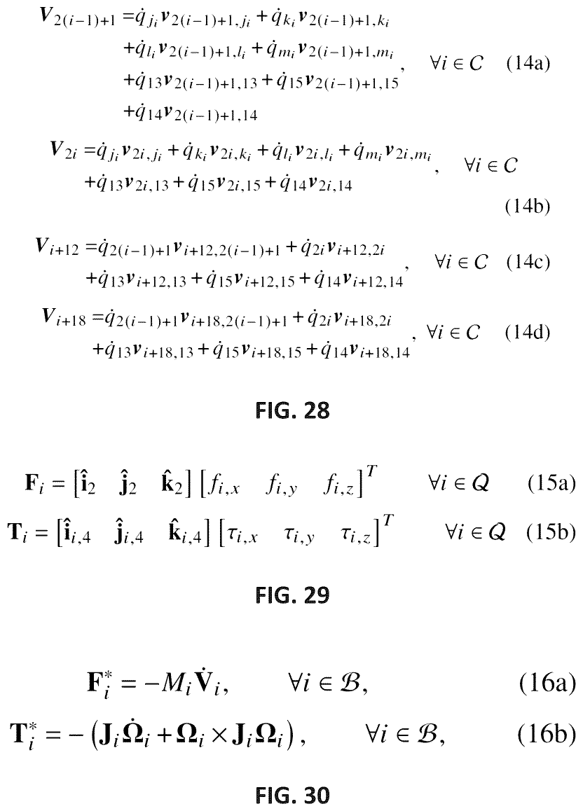

Velocity of every part i∈B is obtained by taking time derivative of global position of part i∈B given in Equation 8 (Vᵢ=.rᵢ), and obtained by Equations 14a-14d, shown in FIG. 28.

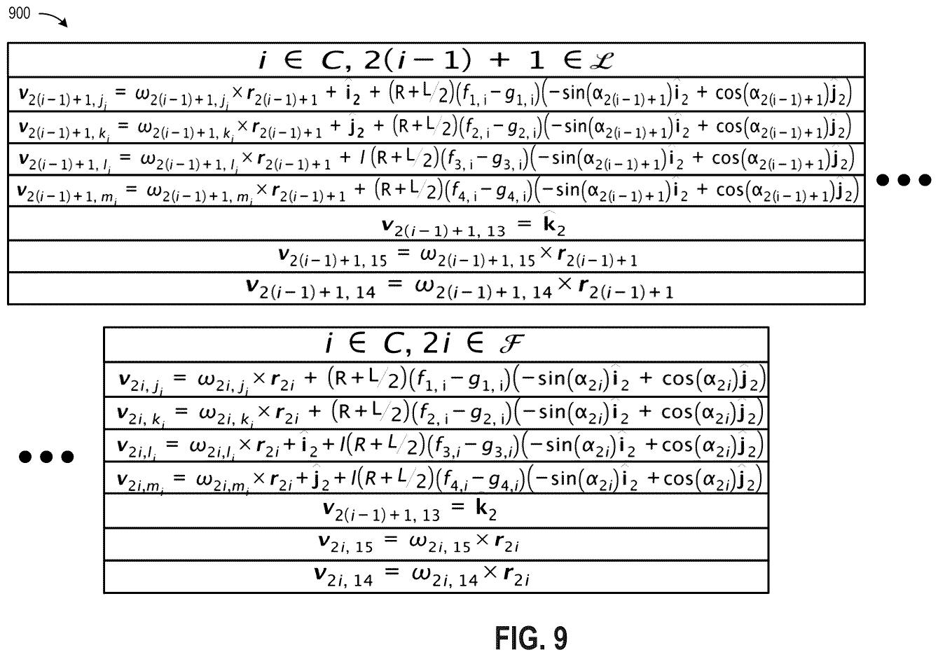

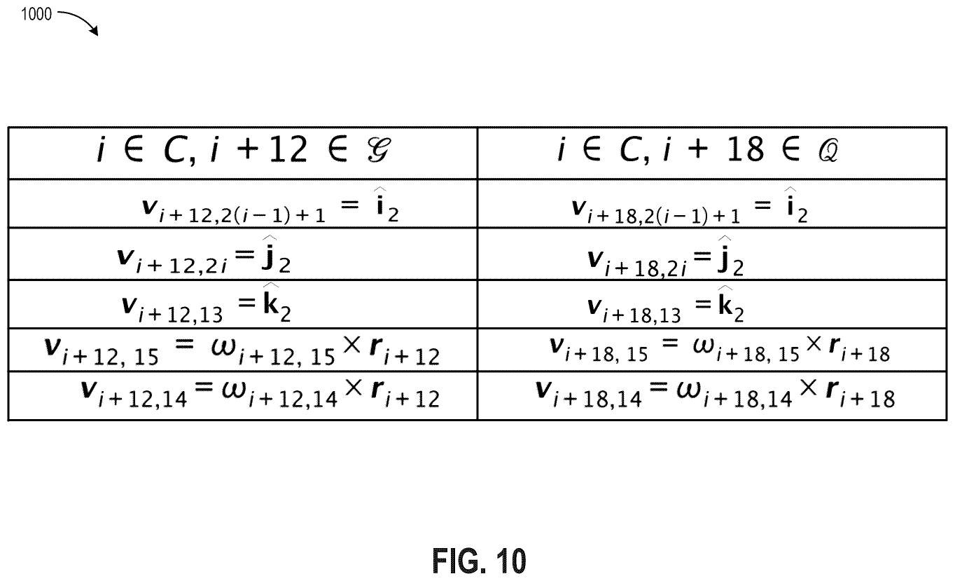

The non-zero generalized velocity vectors of the leader and follower bars are given in Table III 900 of FIG. 9 and followed by nonzero generalized velocity vectors of the guides and UAVs listed in Table IV 1000 of FIG. 10. Note that “x” is the cross product symbol in Table III 900 and Table IV 1000.

Angular acceleration of part i∈B is denoted by \dot{ }Ωi and obtained by taking time derivative from angular velocity of part i∈B given in Equations 13a, 13c, 13b, and 13d. Accelerations of parts i∈B are denoted by Vi and obtained by taking time derivative from the velocity of part i∈B given in Equations 14c, 14d, and 14a.

The Kane's method is used to obtain the equation of motion of the DCU. To this end, the generalized active force and moment are defined, produced by UAV i∈Q, as shown in Equations 15a and 15b (FIG. 29).

Furthermore, the generalized inertial force and moment are defined as Equations 16a and 16b, shown in FIG. 30.

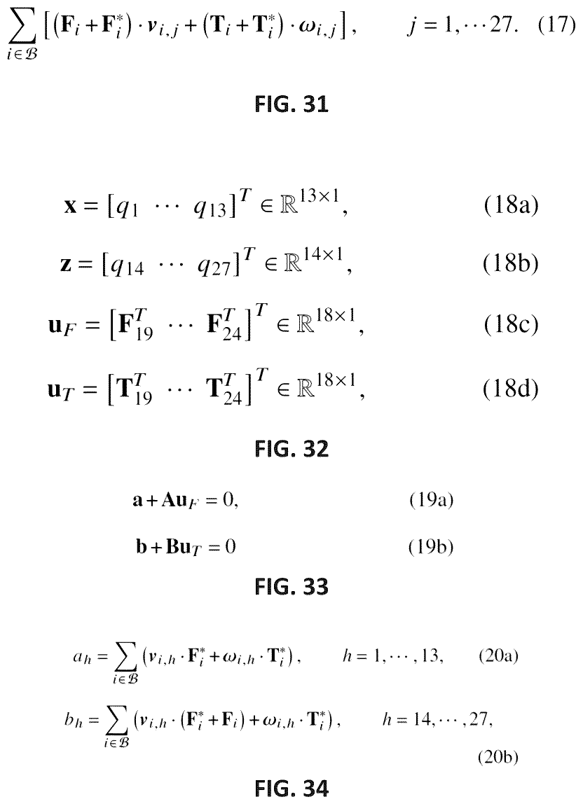

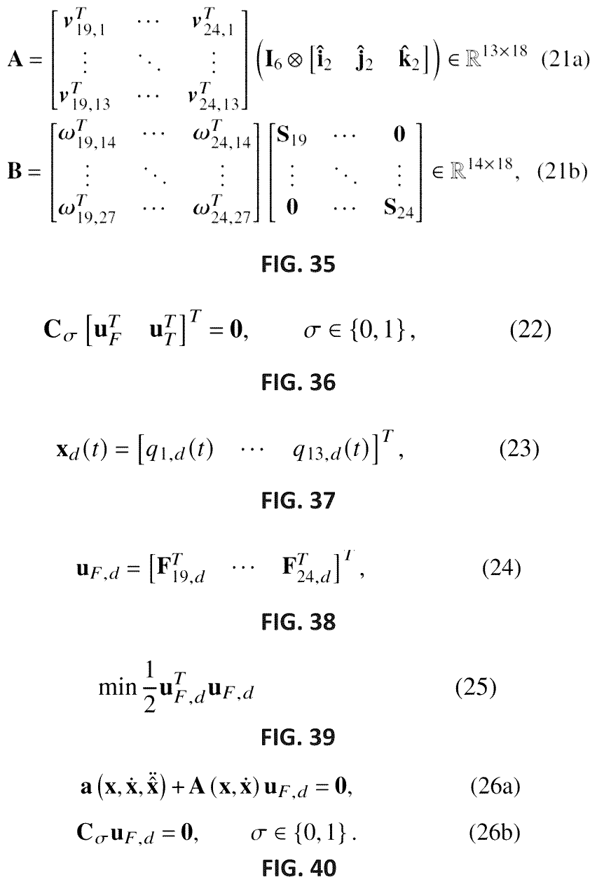

Then the equation of motion of the DCU is obtained by Equation 17, shown in FIG. 31, where “·” is the dot product symbol. Defining Equations 18a-18d (FIG. 32), the DCU dynamics, obtained by Equation 17 is converted to the following translational and rotational dynamics of Equations 19a and 19b, shown in FIG. 33. In Equations 19a and 19b, vectors a=a (x, \dot{ }x, \ddot{ }x)=[aₕ]∈R^{13×1} and b=b (x, z, \dot{ }x, \dot{ }z, \ddot{ }x, \ddot{ }z, u_{F})=[bₕ]∈R^{14×1} are obtained by Equations 20a and 20b, shown in FIG. 34), and A=A(x, \dot{ }x)=[Aⱼₕ]∈R^{13×18} and B=B(x, z, \dot{ }x, \dot{ }z)=[Bⱼₕ]∈R^{14×18} are obtained as shown in Equations 21a and 21b (FIG. 35). Note that “·” is the inner product symbol, “⊗” is the Kronecker product symbol, I₆∈R^{6×6} is the identity matrix, and Si is obtained by Equation 4 for every UAV i∈Q.

In addition to the DCU dynamics presented as equality constraint in Equations 19a and 19b, we can impose Equation 22 (FIG. 36) to incorporate the UAV failure into modeling and control of the DCU. In Equation 22, matrix C1=0 (σ=1) when all multi-copter UASs are healthy. Otherwise, Cσ≠0 (σ=0) which in turn implies that at least one multi-copter UAS is not completely healthy.

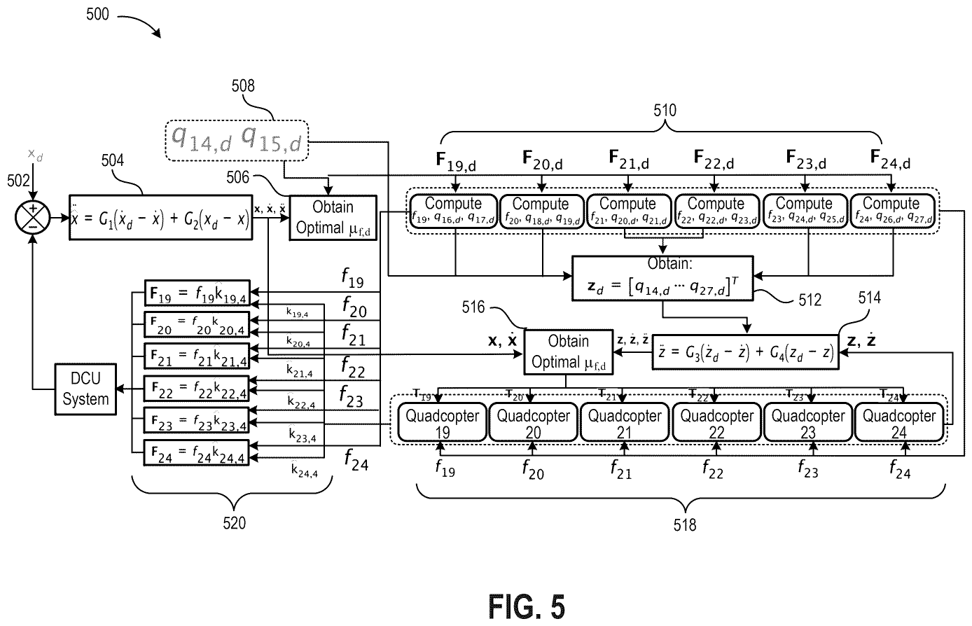

Given the reference roll q_{14,d}(t), reference pitch q_{15,d}(t), reference position component vector Equation 23 (FIG. 37), the DCU motion control objective is that q₁₄ (t), q₁₅ (t), and x(t) stably track q14,d (t), q15,d (t), and xd (t), respectively, by applying a control with the block diagram shown in FIG. 5. This motion control problem is decomposed into three sub-problems: (i) desired control force assignment, (ii) attitude control, and (iii) state update.

The desired thrust forces that need to be generated by UAVs 19 through 24 are aggregated by vector of Equation 24 (FIG. 38), and determined by solving the following optimization problem in Equation 25 (FIG. 39), subject to Equations 26a and 26b (FIG. 40).

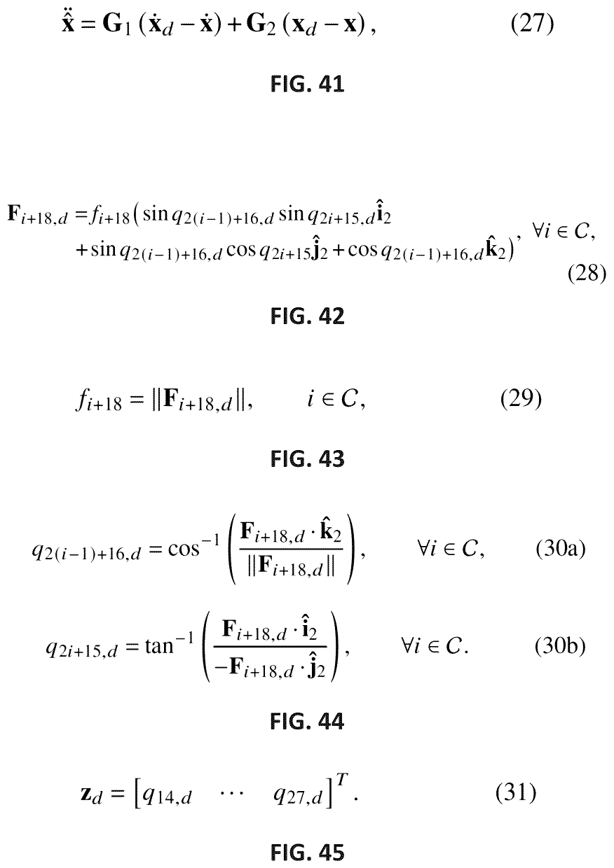

For the above optimization, a(x, \dot{ }x, \ddot{ }x) and A (x, \dot{ }x) are assigned by Equations 20a and 21a, respectively, where \ddot{ }x is substituted by the estimated vector \ddot{ }\hat{ }x(t). Note that \ddot{ }\hat{ }x is the prediction for the second time-derivative of the state vector x(t) at any time t, and updated by Equation 27 (FIG. 41), where G1∈R^{13×13} and G2∈R^{13×13} are constant, positive definite and diagonal matrices.

By solving above optimization, we obtain the desired thrust force F_{i+18,d}, that need to be generated by UAV i+18∈Q, and express it with respect to the DCU body coordinate system as shown in Equation 28 (FIG. 42), where the magnitude of the desired force, given in Equation 29 (FIG. 43) is the same as the actual thrust force magnitude that needs to be generated by UAV i+18∈Q. For given q₁₄(t)=φᵣ(t) and q₁₅(t)=θᵣ(t), \hat{ }i₂, \hat{ }j₂, and \hat{ }k₂ are known at time t, q_{2(i-1)+16,d} and q_{2i+15,d} are obtained as shown in Equations 30a and 30b (FIG. 44).

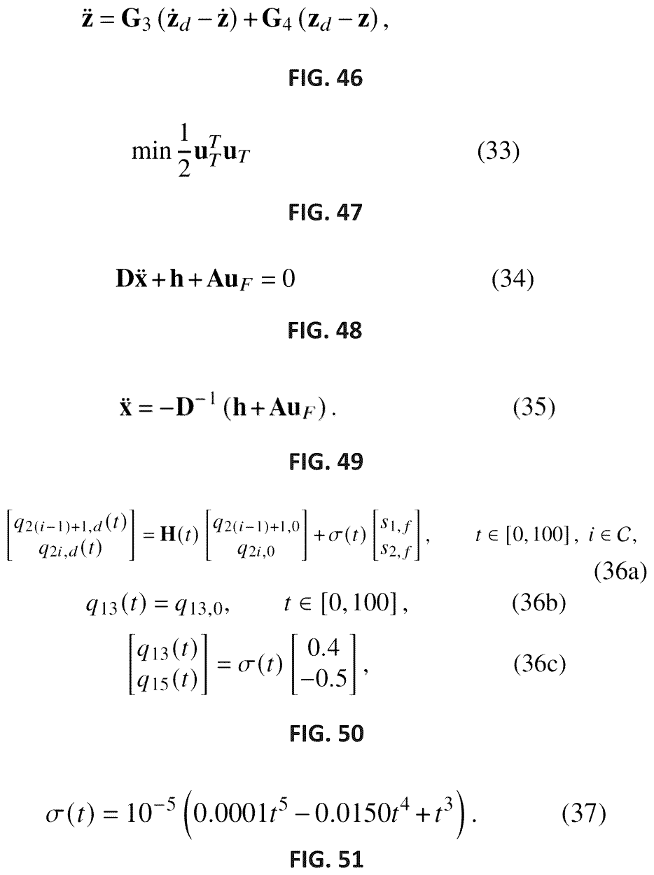

For UAV attitude control, we first define, in Equation 30 (FIG. 45), aggregating q_{14,d} (the desired DCU roll angle), q_{15,d} (the desired DCU pitch angle), and desired roll and yaw angles of UAVs 19 through 24, assigned by Equations 30a and 30b. Then, vector z is updated, aggregating q₁₄, q₁₅, and actual roll and yaw angles of UAVs 19 through 24, by Equation 32 (FIG. 46) where G3∈R^{12×12} and G4∈R^{12×12} are constant, positive definite and diagonal matrices. By knowing z, \dot{ }z, \hat{ }z, x, \dot{ }x, and \hat{ }x, control vector u_{T}, aggregating actual torques provided by UAVs 19 through 24, are obtained by solving the following optimization problem of Equation 33 (FIG. 47), subject to equality constraint of Equation 19b.

To update the state vector x, by using Eq. (19a), we first compute the control vector u_{F}, aggregating the actual thrust force vectors F19 through F24, provided by UAVs 19 through 24, where ∥Fᵢ₊₁₈∥=∥F_{i+18,d}∥, for i∈C. Then, we express a as a (x, \dot{ }x, \hat{ }x)=D(x, \dot{ }x)\hat{ }x+h (x, \dot{ }x), and rewrite Equation 19a as shown in Equation 34 (FIG. 48). Therefore, the state x is updated by the following second-order dynamics of Equation 35 (FIG. 35).

The results of a simulation follow. First presented are simulation results continuum deformation of fully-actuated DCU in Section IV-A where σ=1 and C1=0 (See Eq. (22)). The results of the DCU's failure-resistant operation, when σ=0 and C0≠0, are then given.

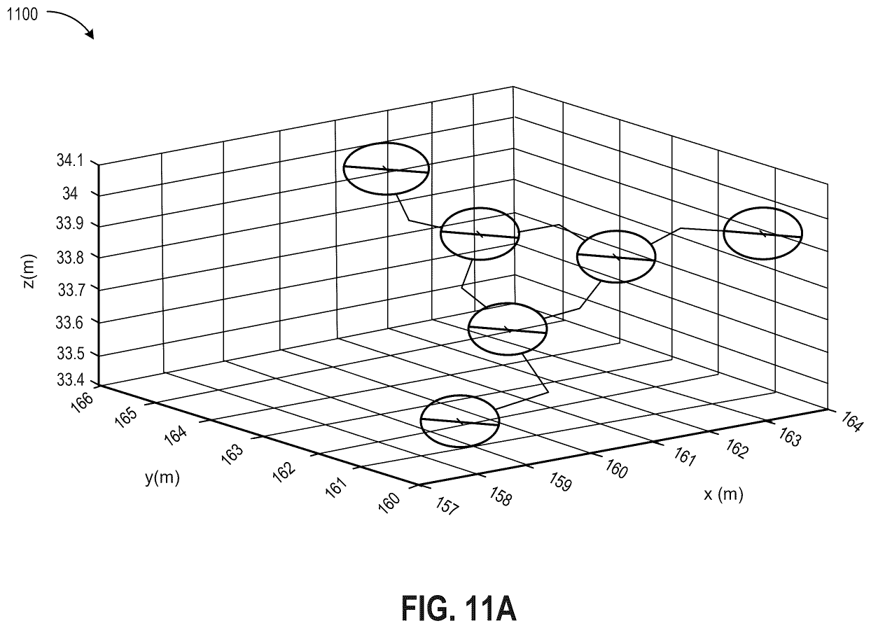

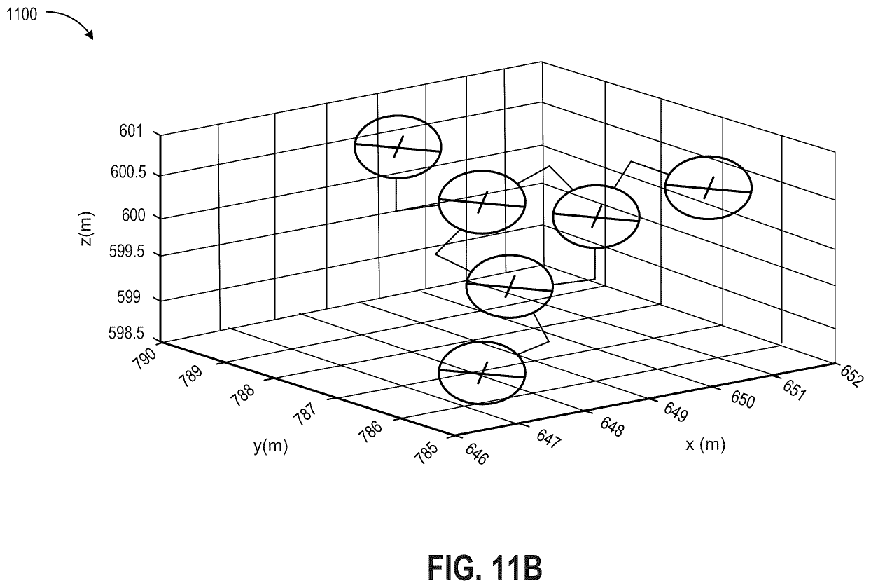

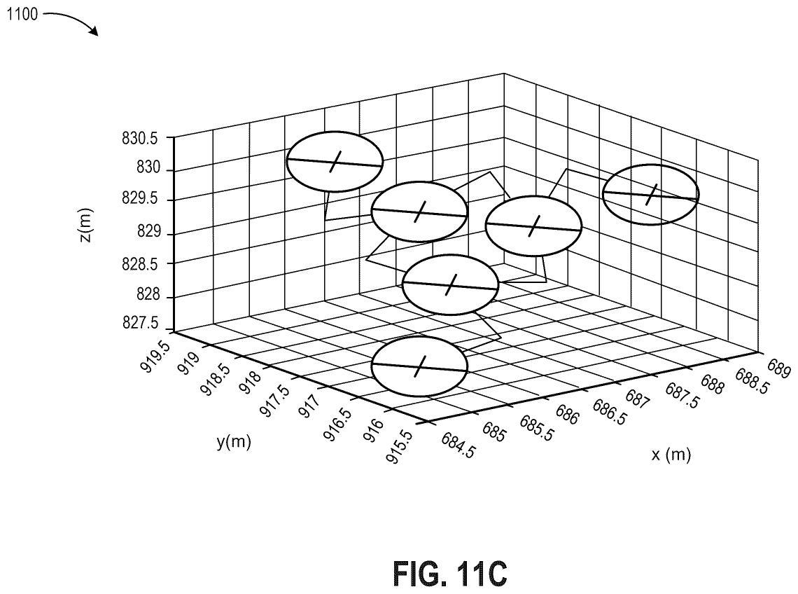

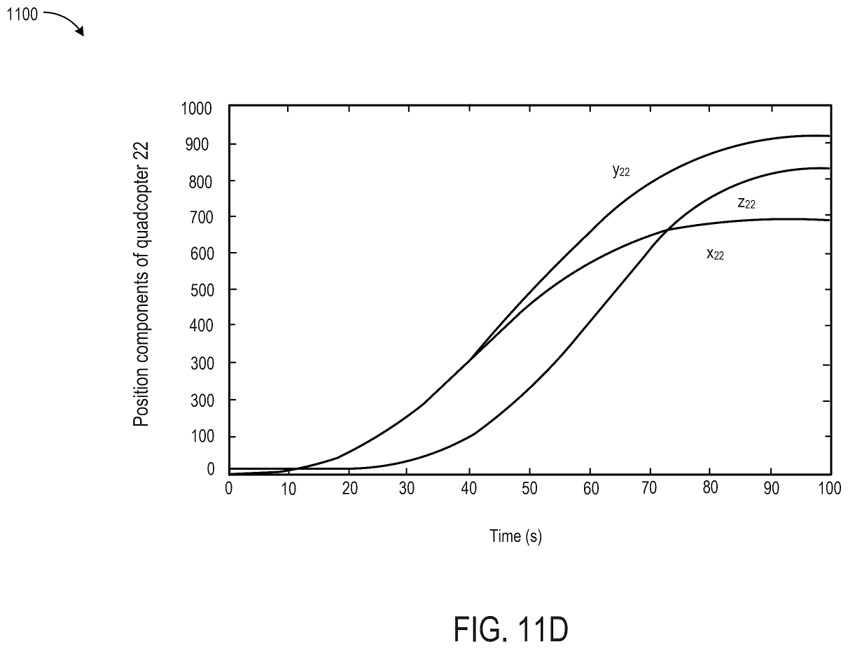

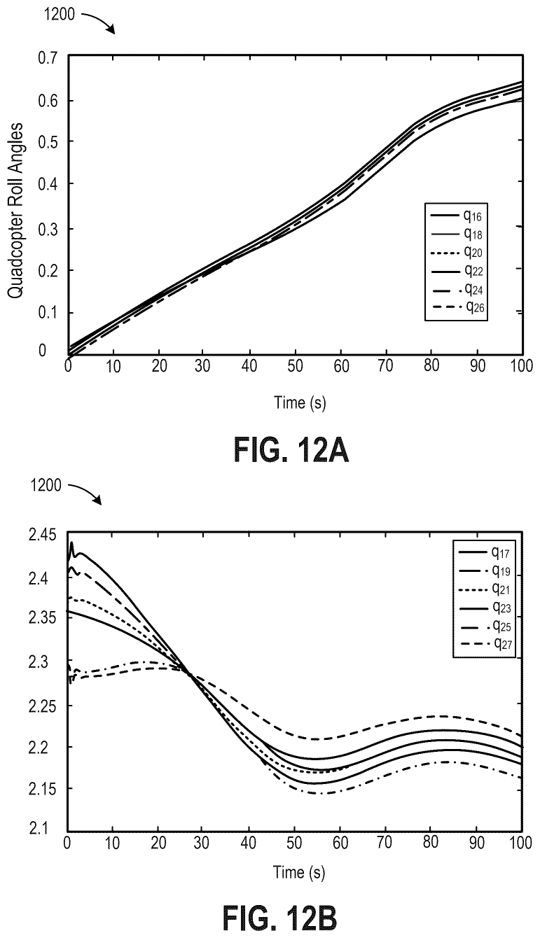

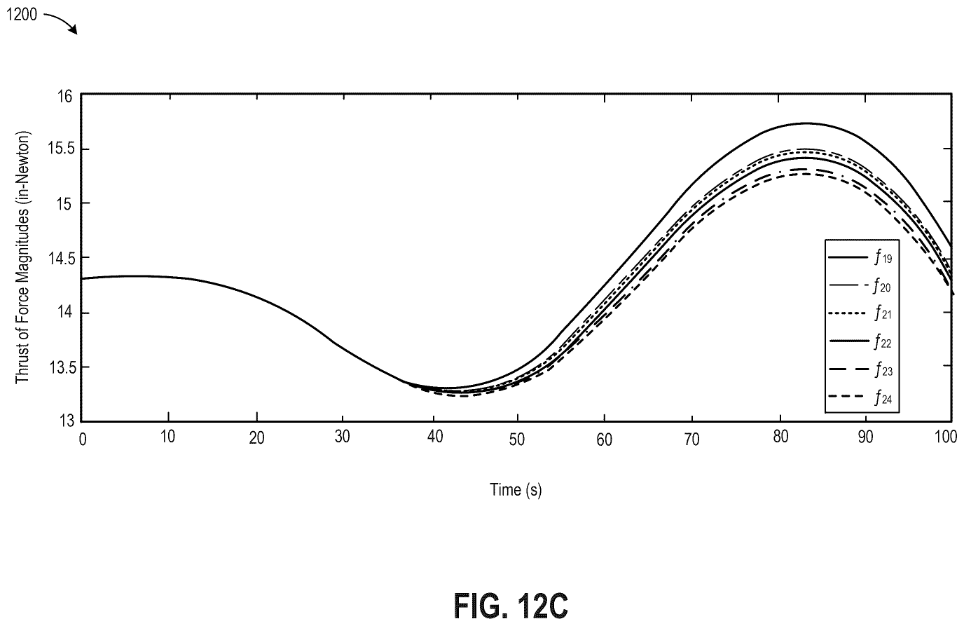

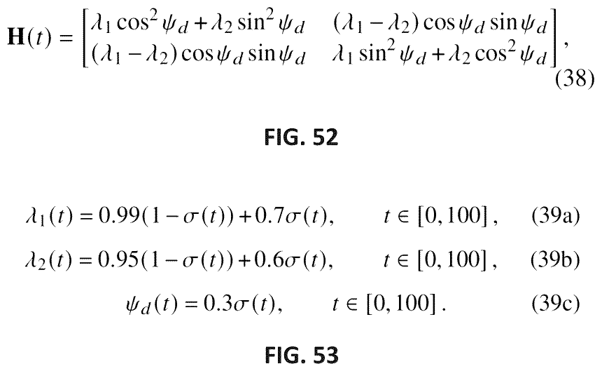

An affine transformation of the DCU is considered at which q_{1,d}(t) through q_{15,d} are defined by Equations 36a-36c, as shown in FIG. 50, with q_{1,0}=2.70m, q_{2,0}=−1.5m, q_{3,0}=0m, q_{4,0}=3m, q_{5,0}=−2.70m, q_{6,0}=−1.5m, q_{7,0}=0.99m, q_{8,0}=−0.55m, q_{9,0}=0m, q_{10,0}=1.1m, q_{11,0}=−0.99m, q_{12,0}=−0.55m, q_{13,0}=10m, q_{14,0}=0 rad, q_{15,0=0} rad, q_{14, f}=0.4 rad, q_{15, f}=−0.5 rad, s_{1, f}=1000m, s_{2, f}=1000m, and Equation 37 (FIG. 51). Note that σ is increasing over [0,100], where σ(0)=0, σ(100)=1, .σ(0)=.σ(100)=0, and .\dot{ }σ(0)=.σ(100)=0. Also, H(t) is a positive definite matrix, thus, it can be decomposed as Equation 38, as shown in FIG. 52, where eigenvalues of H, denoted by λ1 and λ2, and shear deformation angle ψd are defined as follows in Equations 39a-39c (FIG. 53). FIGS. 11A-11C show the DCU configurations at sample times 30s, 70s, and 100s. Also, the actual position of UAV 22, obtained by [x22 (t) y22 (t) z22 (t)]T=q7 (t)\hat{ }i2 (t)+q8 (t)\hat{ }j2 (t)+q13 (t)\hat{ }k2 (t) are plotted versus time in FIG. 11D. FIGS. 12A and 12B plot the UAV roll and yaw angles versus time. Also, the thrust force magnitudes generated by UAVs 19 through 24 generated over time interval [0,100] s are plotted versus time in FIG. 12C.

To explain the failure-resilient nature of the DCU operation, a case study is presented. For this case study, we simulate motion of the DCU over [0,100] s where λ1 (t)=0.8, λ2 (t)=0.7, ψd (t)=0.3, and q14 (t)=q15 (t)=0 remain constant at any time t∈[0,100]. Therefore, the DCU moves as a rigid body in a 3-D motion space where the desired trajectories of the center of the DCU is plotted versus time in FIG. 13.

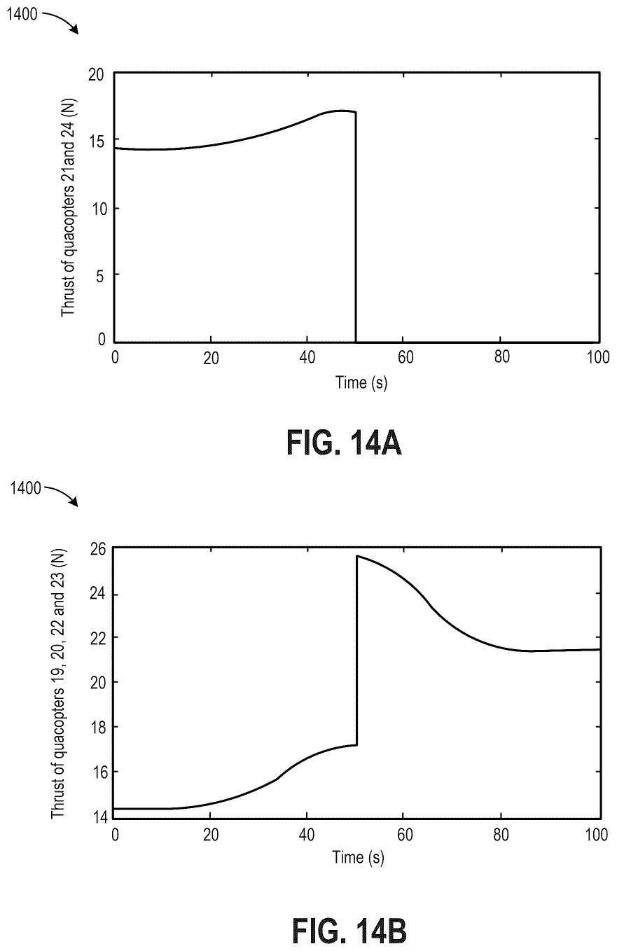

For this case study, it is assumed that UAVs 21 and 24 fail at time t=50, thus, the control thrusts and moments are generated by UAVs 19, 20, 22, and 23 over time interval (50,100]. The thrust magnitudes generated by the healthy and failed UAVs are plotted versus time in FIGS. 14A and 14B. FIG. 14A shows the thrust force magnitudes of UAVs 21 and 24 generated over time interval [0,100] s, while FIG. 14B shows the thrust force magnitudes of UAVs 19, 20, 22, and 23 generated over time interval [0,100] s.

Disclosed above are the control and dynamics models for a novel unmanned aerial vehicle that can deform aggressively in a 3-D motion space. The DCU motion and deformation specified by an affine transformation in a 3-D motion space were simulated using the disclosed model. The DCU enables redundant power sources, produced by many UAVs, to resiliently follow a desired trajectory and deformation in the presence of actuation failures. Due to the structural rigidity of the vehicle in all planes that are normal to the DCU deformation plane, the DCU improves the tolerance and resistance against exogenous disturbance forces.

FIG. 5 is an example block-diagram of DCU motion control, consistent with the present disclosure. In addition to the above discussions, the block-diagram of FIG. 5 is further describe in the operations of the flow chart diagram of FIG. 6 below. The functions illustrated in the example block diagram of FIG. 5 and executed according to the flow chart diagram of FIG. 6, may be performed, for example, by the controller circuitry 152 of FIG. 1.

FIG. 6 is a flow chart diagram depicting operations for an illustrative example embodiment of a method 600 for control of a configurable unmanned aerial vehicle system on the system 100 of FIG. 1, consistent with the present disclosure. In an alternative embodiment, the operations of method 600 may be performed by any other program while working with method 600.

It should be appreciated that embodiments of the present disclosure provide at least for control of a configurable unmanned aerial vehicle system. However, FIG. 6 provides only an illustration of one implementation and does not imply any limitations with regard to the environments in which different embodiments may be implemented. Many modifications to the depicted environment may be made by those skilled in the art without departing from the scope of the disclosure as recited by the claims.

The operations of method 600 are described with reference to the example block diagram of FIG. 5. The example of FIG. 5 is based on the configuration of DCU 200A and DCU 200B of FIG. 2. In these example configurations, the DCU consists of six UAVs. In the configuration of FIGS. 2A and 2B, the individuals UAVs are numbered from 19 through 24. This configuration will be used in the description of method 600 that follows. It should be noted that although this example represents only one possible configuration of a DCU, many other configurations of UAVs could be used in the DCU, as would be known by those skilled in the art.

Receive desired position (operation 602). In the illustrated example embodiment, a desired position 502 for the DCU is received. The desired position 502, x_{d}, contains 2n+1 position components for n UAVs.

Determine desired acceleration (operation 604). In operation 604, the desired acceleration, \ddot{ }\hat{ }x, is determined based on the desired position 502 received in operation 602. The formula for determining the desired acceleration is shown in block 504 of FIG. 5, as well as in Equation 26 above. The desired acceleration \ddot{ }\hat{ }x is used to obtain an optimal aggregate thrust forces u_{f,d} that are determined in block 506 for each of the n UAVs to achieve the desired acceleration.

For each UAV, determine the desired thrust force and desired angle required to reach the desired position (operation 606). In operation 606, the desired thrust force, the desired roll angle, and the desired pitch angle required to reach the desired position 502 are obtained for each UAV, as shown in block 510. For the example configuration of FIG. 5, for the first UAV in block 510, UAV 19, the desired thrust force is f₁₉, the desired roll angle is q_{16,d}, and the desired pitch angle is q_{17,d}. The determination of the desired thrust force, the desired roll angle, and the desired pitch angle are explained above.

Determine a global desired angle for all UAVS from the desired angle for each of the UAVS and the actual orientation of the DCU in the plane (operation 608). In operation 608, once the desired thrust force, the desired roll angle, and the desired pitch angle required to reach the desired position are obtained for each UAV, they are aggregated into a global desired roll angle and desired pitch angle in block 512, which combines the desired roll angle and the desired pitch angle for each UAV with the desired orientation 508 of the DCU in the plane, where the desired orientation 508 of the DCU is composed of the desired DCU roll angle and the desired DCU pitch angle. The resulting global desired angle is vector z_{d}.

Determine global actual angles for all UAVS from the individual desired angles (operation 610). In operation 610, a global actual angles vector, \ddot{ }z, is determined from the desired pitch angle and roll angle for each UAV that was determined in operation 606 and the desired orientation 508 of the DCU in the plane, along with an error data received from the UAVs in block 518 of FIG. 5. This is shown in block 514 of FIG. 5. The actual thrust moment for each UAV in the DCU is determined in block 516 of FIG. 5.

Determine the optimal thrust moment for each UAV (operation 612). In operation 612, an optimal control vector u_{M} is determined based on the global actual angles vector \ddot{ }z that was determined in operation 610 and the position and desired acceleration that were determined in block 504 of FIG. 5.

Send thrust moment to each UAV (operation 614). In operation 614, the actual thrust moment that was determined in operation 612 and the desired thrust force, the desired roll angle, and the desired pitch angle required to reach the desired position that were determined in operation 606 are sent to the individual UAVs in block 518. The actual thrust moment from each UAV is then fed back into block 514 as error data to correct the thrust force, roll angle, and pitch angle for each UAV in the DCU to continuously adjust the thrust force, pitch angle, and roll angle of each UAV in the DCU to achieve the desired position 502.

According to one aspect of the disclosure there is thus provided an unmanned vehicle system, the system including: a first non-terminal cell enclosing a first plurality of terminal cells, each of the first plurality of terminal cells enclosing a respective unmanned arial vehicle (UAV); a second non-terminal cell enclosing a second plurality of terminal cells, each of the second plurality of terminal cells enclosing a respective UAV; a first non-terminal cell linkage member fixedly coupled to the first non-terminal cell; a second non-terminal cell linkage member movably coupled to the second non-terminal cell; a non-terminal cell pivot joint to pivotally couple the first and second non-terminal cell linkage members; wherein the first and second non-terminal cells are arranged in a single plane, and first and second non-terminal cell linkage members and the non-terminal cell pivot joint provide controllable movement of the first and second non-terminal cells with respect to one another and within the single plane; and controller circuitry to control each respective UAV to generate a target upward force generated by each respective UAV, a target roll of each respective UAV, a target pitch of each respective UAV and a target position of the first non-terminal cell with respect to the second non-terminal cell within the single plane.

According to another aspect of the disclosure, there is thus provided a non-transitory storage device that includes machine-readable instructions that, when executed by one or more processors, cause the one or more processors to perform operations. The machine-readable instruction including: receiving a desired position for a plurality of connected unmanned arial vehicles (UAVs) arranged in a single plane; determining a desired acceleration for the plurality of connected UAVs; for each UAV of the plurality of connected UAVs, determining a desired thrust force and a desired angle required to reach the desired position; determining a global desired angle for each UAV of the plurality of connected UAVs; determining a global actual angle for each UAV of the plurality of connected UAVs from an individual desired angles; determining an optimal thrust moment for each UAV of the plurality of connected UAVs; and sending the optimal thrust moment to each UAV of the plurality of connected UAVs.

According to yet another aspect of the disclosure, there is thus provided an unmanned vehicle system, the system including: a planar structure, the planar structure further comprising: a plurality of cells, each of the plurality of cells enclosing a respective unmanned arial vehicle (UAV) arranged in a single plane; a first cell linkage member fixedly coupled to a first cell; a second cell linkage member movably coupled to a second cell; a cell pivot joint to pivotally couple the first and second cell linkage members; wherein the first and second cell linkage members and the cell pivot joint provide controllable movement of the first and second cells with respect to one another and within the single plane; and controller circuitry, the controller circuitry configured to: generate a target upward force generated by each respective UAV; generate a target roll of each respective UAV; generate a target pitch of each respective UAV; and generate a target position of the first cell with respect to the second cell within the single plane.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors or controllers comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system, a method, and/or a computer program product. The system or computer program product may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in one or more non-transitory computer readable storage media within the respective computing/processing device.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or other Programmable Logic Devices (PLD) may execute the computer readable program instructions by utilizing state information of the computer readable program instructions to personalize the electronic circuitry, in order to perform aspects of the present disclosure.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. An unmanned vehicle system, comprising:
a first non-terminal cell enclosing a first plurality of terminal cells, each of the first plurality of terminal cells enclosing a respective unmanned arial vehicle (UAV);
a second non-terminal cell enclosing a second plurality of terminal cells, each of the second plurality of terminal cells enclosing a respective UAV;
a first non-terminal cell linkage member fixedly coupled to the first non-terminal cell;
a second non-terminal cell linkage member movably coupled to the second non-terminal cell;
a non-terminal cell pivot joint to pivotally couple the first and second non-terminal cell linkage members; wherein the first and second non-terminal cells are arranged in a single plane, and first and second non-terminal cell linkage members and the non-terminal cell pivot joint provide controllable movement of the first and second non-terminal cells with respect to one another and within the single plane; and
controller circuitry to control each respective UAV to generate a target upward force generated by each respective UAV, a target roll of each respective UAV, a target pitch of each respective UAV and a target position of the first non-terminal cell with respect to the second non-terminal cell within the single plane.

2. The unmanned vehicle system of claim 1, wherein the controller circuitry includes comparator circuitry to compare the target upward force generated by each respective UAV, the target roll of each respective UAV, the target pitch of each respective UAV, and the target position of each respective UAV to an actual force generated by each respective UAV, an actual roll of each respective UAV, an actual pitch of each respective UAV and an actual position of each respective UAV to generate error data.

3. The unmanned vehicle system of claim 2, wherein the controller circuitry also to generate a second time derivative data based on the error data.

4. The unmanned vehicle system of claim 1, wherein the controller circuitry also to perform aggressive deformation and reconfiguration of the unmanned vehicle system while avoiding collisions between each respective UAV of the first plurality of terminal cells and each respective UAV of the second plurality of terminal cells.

5. The unmanned vehicle system of claim 1, wherein each respective UAV further comprises one or more sensors.

6. The unmanned vehicle system of claim 5, wherein the one or more sensors includes at least one of a positional sensor, a rotational sensor, a Global Positioning System (GPS) sensor, or an Inertial Measurement Unit (IMU) sensor.

7. The unmanned vehicle system of claim 1, wherein each of the first plurality of terminal cells and each of the second plurality of terminal cells configured to prevent collisions between any respective UAV and any other respective UAV.

8. A non-transitory storage device that includes machine-readable instructions that, when executed by one or more processors, cause the one or more processors to perform operations, comprising:
receiving a desired position for a plurality of connected unmanned arial vehicles (UAVs) arranged in a single plane;
determining a desired acceleration for the plurality of connected UAVs;
for each UAV of the plurality of connected UAVs, determining a desired thrust force and a desired angle required to reach the desired position;
determining a global desired angle for each UAV of the plurality of connected UAVs;
determining a global actual angle for each UAV of the plurality of connected UAVs from an individual desired angles;
determining an optimal thrust moment for each UAV of the plurality of connected UAVs; and
sending the optimal thrust moment to each UAV of the plurality of connected UAVs.

9. The non-transitory storage device of claim 8, wherein determine the global actual angle for each UAV of the plurality of connected UAVs from the individual desired angles further comprises:
correcting the desired thrust force and desired angle for each UAV of the plurality of connected UAVs using an error data from each UAV to continuously adjust the desired thrust force and the desired angle of each UAV to achieve the desired position.

10. The non-transitory storage device of claim 9, wherein the error data includes an actual thrust moment from each UAV of the plurality of connected UAVs.

11. The non-transitory storage device of claim 8, wherein the desired position contains 2n+1 position components for n UAVs.

12. The non-transitory storage device of claim 8, wherein includes a desired roll angle and a desired pitch angle.

13. The non-transitory storage device of claim 8, wherein determining the optimal thrust moment for each UAV of the plurality of connected UAVs further comprises:
determining an optimal control vector based on a global actual angles vector, a current position, and the desired acceleration.

14. The non-transitory storage device of claim 8, wherein determining the desired acceleration for the plurality of connected UAVs further comprises:
determining an optimal aggregate thrust forces based on the desired acceleration for each UAV.

15. The non-transitory storage device of claim 8, wherein determining the global desired angle for each UAV of the plurality of connected UAVs comprises:
determining a global desired angle for each UAV based on the desired angle for each UAV and an actual orientation of the plurality of connected UAVs in the single plane.

16. An unmanned vehicle system, comprising:
a planar structure, the planar structure further comprising:
a plurality of cells, each of the plurality of cells enclosing a respective unmanned arial vehicle (UAV) arranged in a single plane;
a first cell linkage member fixedly coupled to a first cell;
a second cell linkage member movably coupled to a second cell;
a cell pivot joint to pivotally couple the first and second cell linkage members;
wherein the first and second cell linkage members and the cell pivot joint provide controllable movement of the first and second cells with respect to one another and within the single plane; and
controller circuitry, the controller circuitry configured to:
generate a target upward force generated by each respective UAV;
generate a target roll of each respective UAV;
generate a target pitch of each respective UAV; and
generate a target position of the first cell with respect to the second cell within the single plane.

17. The unmanned vehicle system of claim 16, wherein the controller circuitry includes comparator circuitry, the comparator circuitry configured to:
compare the target upward force generated by each respective UAV, the target roll of each respective UAV, the target pitch of each respective UAV, and the target position of each respective UAV to an actual force generated by each respective UAV, an actual roll of each respective UAV, an actual pitch of each respective UAV and an actual position of each respective UAV to generate error data; and wherein the controller circuitry also to generate second time derivative data based on the error data.

18. The unmanned vehicle system of claim 16, wherein the controller circuitry also to perform aggressive deformation and reconfiguration of the unmanned vehicle system while avoiding collisions between each respective UAV and any other UAV in the unmanned vehicle system.

19. The unmanned vehicle system of claim 18, wherein the controller circuitry also to perform planning the aggressive deformation using a nonsingular transformation to assure collision avoidance between the plurality of cells.

20. The unmanned vehicle system of claim 18, wherein each respective UAV further comprises one or more sensors, the one or more sensors selected from a group consisting of a positional sensor, a rotational sensor, a Global Positioning System (GPS) sensor, and an Inertial Measurement Unit (IMU) sensor.
